(19) United States
(12) Patent Application Publication
(10) Pub. No.: US 2018/0178863 A1
(43) Pub. Date: Jun. 28, 2018

(54) SPARE TIRE AND RIM THEFT PREVENTION DEVICE

(71) Applicants: Ronald A. Vari, Burr Ridge, IL (US); John W. Reidl, Tinley Park, IL (US)

(72) Inventors: Ronald A. Vari, Burr Ridge, IL (US); John W. Reidl, Tinley Park, IL (US)

(21) Appl. No.: 15/855,829

(22) Filed: Dec. 27, 2017

Related U.S. Application Data
(60) Provisional application No. 62/498,419, filed on Dec. 27, 2016.

(51) Int. Cl. B62D 43/00; B62D 43/04

(52) U.S. Cl. CPC B62D 43/007; B62D 43/045

(57) ABSTRACT

An apparatus comprises a retainer to couple to a proximal end of a cable, wherein a distal end of the cable is attached to a motor vehicle. The apparatus further comprises a first tube assembly coupled to a first surface of the retainer. The first tube assembly comprises a first tube, having a first end and a second end, a first length, and a first inner and outer diameter. The first tube assembly further comprises a second tube configured to receive the first tube, with the second tube further comprising a first end and a second end, a second length, a second inner diameter that is greater than the first outer diameter, and a second outer diameter. The apparatus further comprises a second tube assembly coupled to a second surface of the retainer, the second tube assembly comprising a third tube and a fourth tube.

### PRIORITY CLAIM

This application claims priority to Provisional Application No. 62/498,419, filed Dec. 27, 2016.

### BACKGROUND

Motor vehicles may come equipped with a spare tire for use in the event of a flat tire. In some examples, the spare tire may be coupled to the vehicle by a cable assembly. A spare tire coupled to a motor vehicle may be susceptible to theft due to the ability of a cable to be cut.

### BRIEF DESCRIPTION OF THE DRAWINGS

FIG. 1 shows a perspective and deconstructed view of the first tube assembly.

FIG. 2 shows a perspective and deconstruction view of the second tube assembly.

FIG. 3 shows a view of the first cylinder as coupled to the cable.

FIG. 4 shows the first tube assembly.

FIG. 5 shows the first and second tube assemblies as assembled on a cable and with a retainer.

FIG. 6 is a perspective view of the first and second tube assemblies, as well as the block plate and the fifth tube.

### DETAILED DESCRIPTION

Motor vehicles may rely on tires for movement. Due to the material making up the tire (e.g., rubber), a tire may experience incidents, such as punctures, that lead to the air contained within the tire being released. This may be referred to as a “flat” tire or simply a “flat”. In order to continue traveling by a motor vehicle when a flat has occurred, the flat tire should be removed and a different, non-flat, tire should be installed. To this end, many motor vehicles come equipped with a spare tire. The spare tire may be retrieved in the event of a flat and installed in place of the flat tire to allow continued use of the motor vehicle.

A spare tire may be contained within the motor vehicle itself. For example, a spare tire may be located underneath the carriage of the motor vehicle or may be housed in a well designed to hold the spare tire. A spare tire that is located underneath the carriage of a motor vehicle may be coupled to the motor vehicle by a cabling system. The cabling system may retain the spare tire in a raised position but may permit the spare tire to be lowered should the spare tire be needed.

While cabling may provide relatively easy access to a spare tire, the spare tire may be removed when not desired by cutting through the cabling. Although cables may be made of sufficient thickness to make cutting through the cable more difficult, it may be difficult to balance a desire for relative lightness of the system with the desire to prevent theft of the spare tire.

Accordingly, the present disclosure relates to an apparatus for a spare tire system to prevent or deter theft. A first tube assembly comprising a first tube and second tube may be coupled to a retainer at a first surface of the retainer. A second tube assembly comprising a third tube and a fourth tube may be coupled to the retainer at a second surface of the retainer. A fifth tube may further be coupled to a cable at a location above the first tube assembly, the retainer, and the second tube assembly.

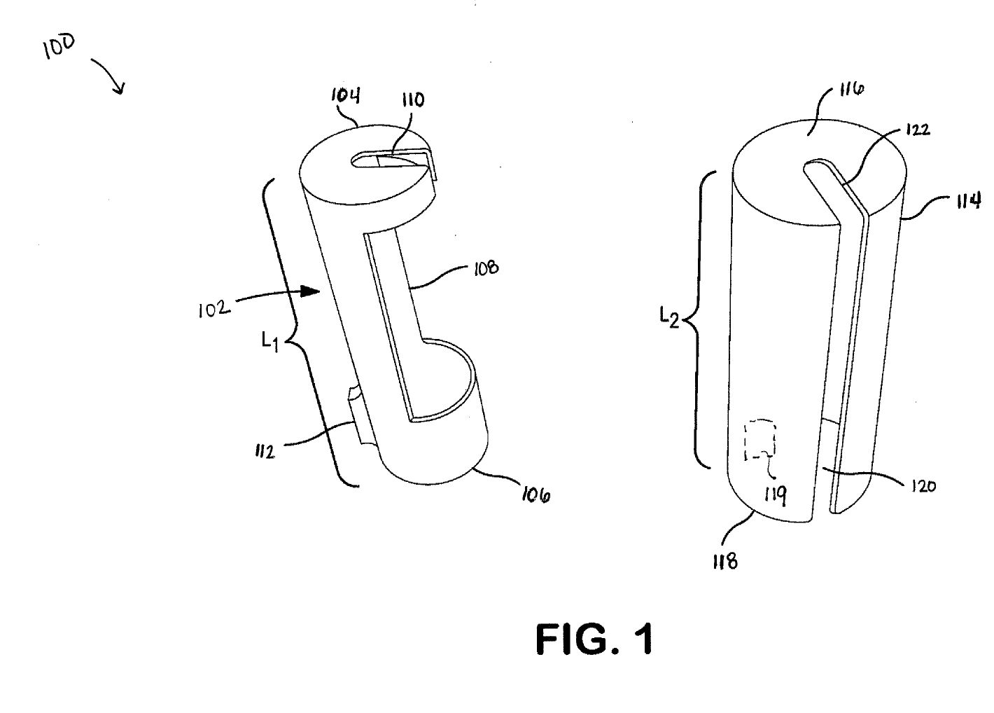

FIG. 1 shows a perspective and deconstructed view of the first tube assembly 100. The first tube assembly 100 comprises a first tube 102 and a second tube 114. As used herein, a tube refers to a generally cylindrical apparatus with a particular cross sectional shape. Although first tube 102 and second tube 114 are shown to have generally circular cross-sectional shapes, examples are not so limited, and any cross-sectional shape may be used in the tubes.

The first tube has a length L₁, which may be between three inches and six inches, although examples are not so limited. First tube 102 further has an inner diameter (not shown in FIG. 1) and an outer diameter (not shown in FIG. 1). The first tube 102 further comprises a first end 104 and a second end 106.

The first tube 102 may further include an opening 108. The opening 108 may be sized to permit a spring (not shown in FIG. 1) to be inserted into first tube 102. Additionally, first tube 102 may include an opening 110. Opening 110 may be disposed on first end 104 and may be sized to permit a cable to pass through.

Similarly, the second tube 114 has a second length L₂, which may be between three inches and six inches, although examples are not so limited. Second tube 114 further has an inner diameter and an outer diameter (not shown in FIG. 1). Further, second tube 114 has a first end 116 and a second end 118.

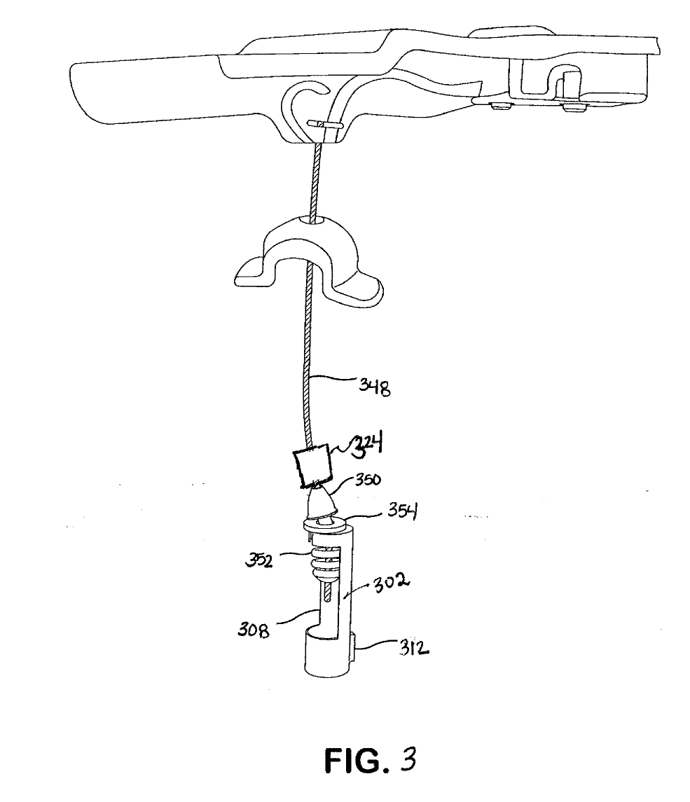

Second tube 114 further includes a slot 120. As used herein, a slot refers to a narrow aperture or slit formed within an object. As shown in FIG. 1, slot 120 extends along L₂ of second tube 114, running from the first end 116 to the second end 118. Slot 120 may be sized to accommodate a cable when first tube assembly 100 is engaged with a cabling system for a spare tire. Moreover, second tube 114 may include an opening 122. As shown in FIG. 1, opening 122 may be disposed on first end 116. Opening 122 may be an extension of slot 120; that is, opening 122 may be formed as part of slot 120. Similar to slot 120, opening 122 may receive a cable when the cable is engaged with first tube assembly 100. The engagement of the first tube assembly 100 is discussed further herein with respect to FIGS. 3-6.

The second tube 114 may further include a Global Positioning System (GPS) chip 119. As used herein, a GPS chip refers to a chip that uses radio waves to triangulate a location of an object. GPS chip 119 may be integrally formed within second tube 114, and may be used to track the first tube assembly 100 should the first tube assembly 100 be removed.

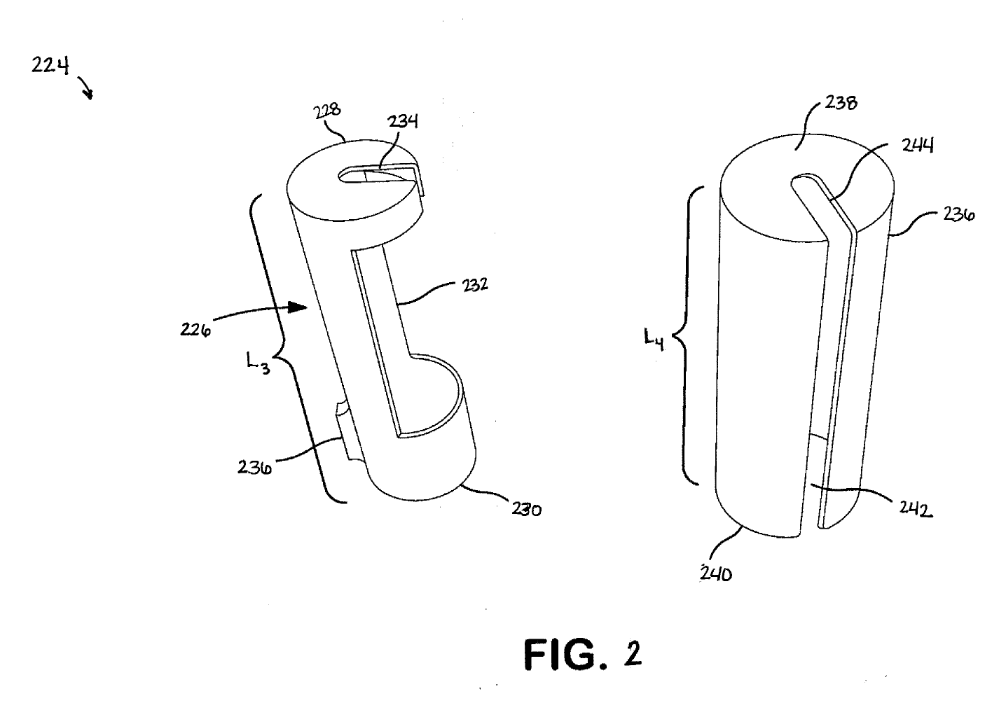

FIG. 2 shows a perspective and deconstructed view of the second tube assembly 224. The second tube assembly 224 comprises a third tube 226 and a fourth tube 236. The third tube has a length L₃. Length L₃ may be smaller than length L₁ or length L₂, described with respect to FIG. 1, although examples are not so limited. Third tube 226 further has an inner diameter (not shown in FIG. 2) and an outer diameter (not shown in FIG. 2). The first tube 226 further comprises a first end 228 and a second end 230.

The third tube 226 may further include an opening 232. Third tube 226 may further include an opening 234. Opening 234 may be disposed on first end 228 and may be sized to permit a cable to pass through.

Similarly, the fourth tube 236 has a second length L₄, which may be smaller than length L₁ or length L₂, described with respect to FIG. 1, although examples are not so limited. Fourth tube 236 further has an inner diameter and an outer diameter (not shown in FIG. 2). Further, second tube 236 has a first end 238 and a second end 240.

Fourth tube 236 further includes a slot 242. As shown in FIG. 2, slot 242 extends along L₄ of fourth tube 236, running from the first end 238 to the second end 240. Slot 242 may be sized to accommodate a cable when first tube assembly 224 is engaged with a cabling system for a spare tire. Moreover, fourth tube 236 may include an opening 244. As shown in FIG. 2, opening 244 may be disposed on first end 238. Opening 244 may be an extension of slot 242; that is, opening 244 may be formed as part of slot 242. Similar to slot 242, opening 244 may receive a cable when the cable is engaged with second tube assembly 224. The engagement of the second tube assembly 224 is discussed further herein with respect to FIGS. 3-6.

FIG. 3 shows a first tube 302 coupled to a cable 348. First tube 302 may be akin to first tube 102, discussed with respect to FIG. 1. First tube 302 has a protrusion 312 extending from the exterior of the first tube 302. The protrusion 312 is generally elongated and sized to fit into a slot or opening, such as opening 120 (discussed with respect to FIG. 1). The protrusion 312 extends partway along length L₁ and is shaped at an upper end to slide easily into a slot or opening. Protrusion 312 may be sized in a direction that is generally perpendicular to the exterior of first tube 302 such that protrusion 312 extends from the exterior of the wall of first tube 302 substantially through the thickness of the second tube (not shown in FIG. 3). Although protrusion 312 is shown disposed towards a bottom of L₁, examples are not so limited and protrusion 312 may be disposed at any location along the length of first tube 302.

First cylinder 302 further includes an opening 308 disposed opposite protrusion 312. Opening 308 may be akin to opening 108, discussed with respect to FIG. 1. As shown in FIG. 3, opening 308 may be sized to receive a spring, such as spring 352. As used herein, a spring refers to a device that is compressible and stretchable while ultimately returning to its original shape. Although spring 352 is shown to be a spiral compression spring, examples are not so limited, and any other type of spring may be used. As shown in FIG. 3, spring 352 may be constructed to couple to an end of cable 348, with cable 348 extending into opening 308 of first tube 302.

The assembly shown in FIG. 3 further includes a flexible member 350. Flexible member 350 may be disposed exterior to the first tube 302 and may be coupled to cable 348. Additionally, a retainer 354 may be disposed beneath the flexible member 350 between the flexible member and the first tube 302.

FIG. 3 additionally shows the second tube assembly 324. As described with respect to FIG. 2, second tube assembly 324 comprises a third tube and a fourth tube. Second tube assembly 324, as shown in FIG. 3, is in the “assembled” position.

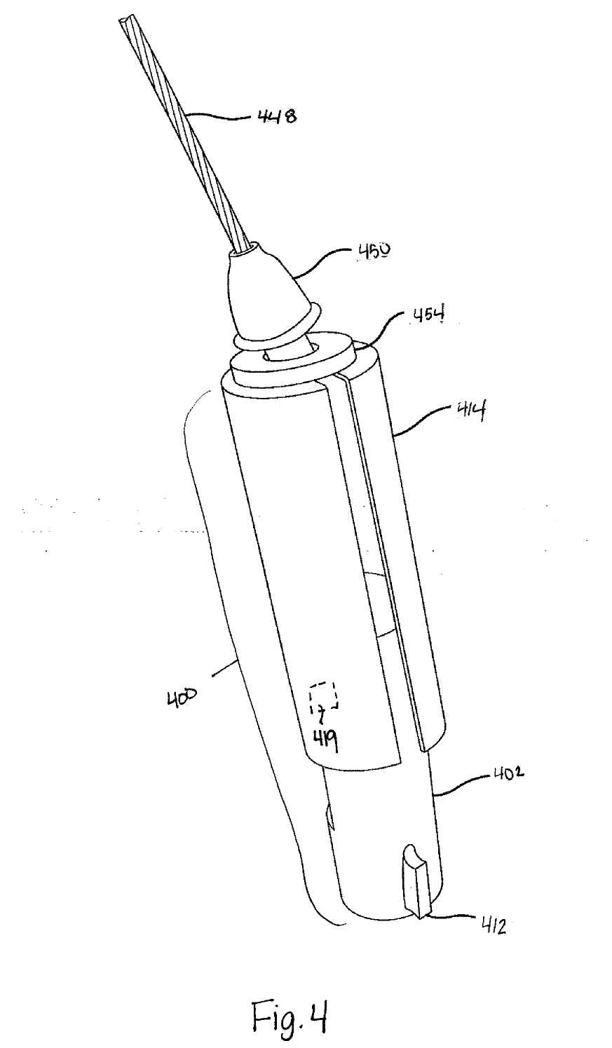

FIG. 4 shows the first tube assembly 400 in assembly. First tube assembly 400 may be akin to first tube assembly 100, described with respect to FIG. 1. As shown in FIG. 4, first tube assembly 400 comprises the first tube 402 and the second tube 414 being coupled together. First tube 402 may be slidably coupled with second tube 414. Moreover, upon coupling of the first tube 402 with the second tube 414, the first tube 402 may be non-rotatable with respect to second tube 414. In some examples, the protrusion 412 may couple with the second tube 414 to prevent rotation of the first tube 402. In some examples, the first tube assembly 400 may be assembled to enclose the cable 448 and/or a spring (not shown in FIG. 4). Additionally, although not shown in FIG. 4, the second tube assembly may be assembled in a similar fashion as first tube assembly 400.

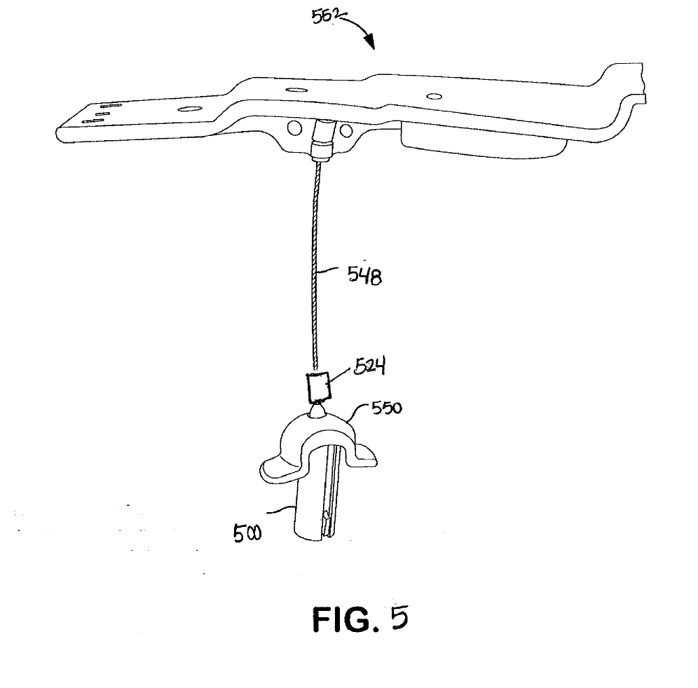

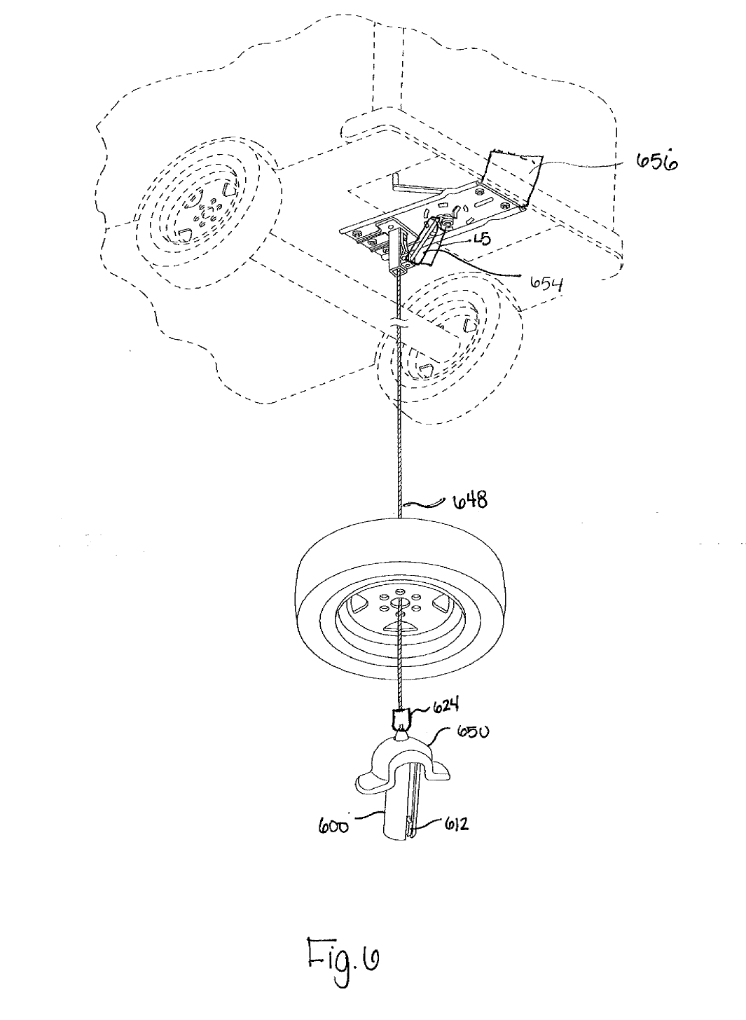

FIG. 5 shows the first tube assembly 500 and the second tube assembly 524 as assembled on a cable 548 and with a retainer 550. A winch 552 may be disposed at an end of the cable 548 distal to the first tube assembly 500 and the second tube assembly 524. As used herein, a winch refers to hauling or lifting device consisting of a rope, cable, or chain winding around a horizontal rotating drum (not shown in FIG. 5). Winch 552 may be used to pull the first tube assembly 500, the second tube assembly 524, and the retainer 550 into position, which is shown further with respect to FIG. 6.

FIG. 6 is a perspective view of the first tube assembly 600, the second tube assembly 624, as well as the fifth tube 654 and the block plate 656. The first tube assembly 600 and the second tube assembly 624 may be pulled into abutment with the retainer 650 by a winch, such as winch 552, discussed with respect to FIG. 5. A washer (not shown in FIG. 6) may abut a spare tire rim to assist in pressing the tire and rim into position with respect to the first and second tube assemblies 600, 624. In some examples, multiple washers may be used, and the washers may be fabricated from any suitable material, including rubber, plastic, or metal.

Additional flexible members not shown in FIG. 6 may be added as well. For example, a flexible member may be disposed between first tube assembly 600 and retainer 650 to protect first tube assembly 600. Similarly, a flexible member may be disposed between second tube assembly 623 and retainer 650.

In operation, the winch may serve to compress the spring (not shown in FIG. 6) to assist in positioning the spare tire and the rim. When the spare tire is positioned correctly, the first tube assembly 600 and the second tube assembly 624, coupled with retainer 650, effectively prevent access to the cable 648.

FIG. 6 shows an additional fifth tube 654. Fifth tube 654 has a length L₅ which may be different than any of L₁-L₄, and may have a first end and a second end. Fifth tube 654 may be slidably coupled with the cable 648. As shown in FIG. 6, fifth tube 654 may slidably couple with cable 648 such that the fifth tube is substantially perpendicular to the first tube assembly 600, the second tube assembly 624, and the retainer 650. Additionally, while fifth tube 654 is shown disposed on an underside of a vehicle, examples are not so limited.

FIG. 6 further shows a mounting plate 656. As used herein, a mounting plate refers to a sheet of durable material used to prevent access to an area, such as an access point for cable 648. Mounting plate 656 may be designed to couple with a motor vehicle. In some examples, the mounting plate 656 may couple with the motor vehicle via plurality of apertures (not shown in FIG. 6). The apertures may permit coupling of the mounting plate 656 by, for example, screws or bolts, although examples are not so limited. In some examples, mounting plate 656 is coupled to an external surface of a motor vehicle. As shown in FIG. 6, the mounting plate 656 may be coupled to the motor vehicle such that the mounting plate 656 is substantially perpendicular to fifth tube 654.

Additionally, mounting plate 656 may include an opening to couple with a lock, such as a padlock or a puck lock. The opening be located substantially central to the mounting plate 656, although examples are not so limited. In operation, a lock may be engaged with the mounting plate 656 at the opening, such that mounting plate 656 is locked into position.

The figures herein follow a numbering convention in which the first digit corresponds to the drawing figure number and the remaining digits identify an element or component in the drawing. Elements shown in the various figures herein may be added, exchanged, and/or eliminated so as to provide a number of additional examples of the present disclosure. In addition, the proportion and relative scale of the elements provided in the figures are intended to illustrate the examples of the present disclosure, and should not be taken in a limiting sense. Further, as used herein, “a number of” an element and/or feature can refer to one or more or such elements and/or features.

In view of the forgoing detailed description, we claim:

1. An apparatus, comprising:
a retainer to couple to a proximal end of a cable, wherein a distal end of the cable is attached to a motor vehicle;
a first tube assembly coupled to a first surface of the retainer, the first tube assembly comprising:
a first tube, the first tube further comprising:
a first end and a second end;
a first length,
a first inner diameter; and
a first outer diameter;
a second tube configured to receive the first tube, the second tube further comprising:
a first end and a second end;
a second length;
a second inner diameter that is greater than the first outer diameter; and
a second outer diameter; and
a second tube assembly coupled to a second surface of the retainer, the second tube assembly comprising:
a third tube, wherein the third tube further comprises:
a first end and a second end;
a third length;
a third inner diameter; and
a third outer diameter; and
a fourth tube configured to receive the third tube, the fourth tube further comprising:
a first end and a second end;
a fourth length;
a fourth inner diameter that is greater than the third outer diameter; and
a fourth outer diameter.

2. The apparatus of claim 1, wherein the retainer, the first tube assembly, and the second tube assembly are configured to couple to a spare tire by the cable such that the spare tire is retained at a location on an underside of the motor vehicle.

3. The apparatus of claim 3, wherein the first tube assembly and an underside of a rim of the spare tire extend substantially below the rim of the spare tire.

4. The apparatus of claim 1, wherein the first tube assembly comprises the first tube slidably inserted into the second tube.

5. The apparatus of claim 3, wherein the first tube is non-rotatable when inserted into the second tube.

6. The apparatus of claim 1, wherein:
the first tube further comprises an aperture having a plurality of edges; and
the plurality of edges flex to permit a cable to extend through the aperture from outside the first tube into an inside of the first tube.

7. The apparatus of claim 1, wherein the first tube further comprises a protrusion extending from an exterior surface of the first tube in a substantially perpendicular direction.

8. The apparatus of claim 1, wherein the first tube further comprises an opening at an exterior surface of the first tube between the first end and the second end and wherein:
the opening is to receive a spring coupled to the cable; and
the opening is to enable the first tube to enter the second tube.

9. The apparatus of claim 8, wherein:
the cable extends through the opening in the first tube and through the opening in the second tube such that the cable is enclosed by first the tube assembly; and
the cable is retained within the first tube assembly by a first flexible member located adjacent to and exterior to the opening of the second tube.

10. The apparatus of claim 9, wherein the first tube has a closed second end such that the second end of the second tube is substantially closed upon entry of the first tube into the second tube.

11. The apparatus of claim 1, wherein the second tube assembly comprises the third tube slidably inserted into the fourth tube.

12. The apparatus of claim 11, wherein the third tube is non-rotatable when inserted into the fourth tube.

13. The apparatus of claim 1, wherein:
the third tube further comprises an aperture having a plurality of edges; and
the plurality of edges flex to permit a cable to extend through the aperture from outside the third tube into an inside of the third tube.

14. The apparatus of claim 1, wherein the third tube further comprises a protrusion extending from an exterior surface of the third tube in a substantially perpendicular direction.

15. The apparatus of claim 1, wherein the third tube further comprises an opening at an exterior surface of the third tube between the first end and the second end and wherein:
the opening is to receive a spring coupled to the cable; and
the opening is to enable the third tube to enter the fourth tube.

16. The apparatus of claim 15, wherein:
the cable extends through the opening in the third tube and through the opening in the fourth tube such that the cable is enclosed by the second tube assembly; and
the cable is retained within the tube assembly by a second flexible member located adjacent to and exterior to the opening of the fourth tube.

17. The apparatus of claim 16, wherein the third tube has a closed second end such that the second end of the fourth tube is substantially closed upon entry of the third tube into the fourth tube.

18. The apparatus of claim 1, further comprising a fifth tube configured to encase the cable on the underside of the motor vehicle, the fifth tube comprising:
a first end and a second end; and
a fifth length.

19. The apparatus of claim 18, wherein the fifth tube is to slidably couple with the cable such that the fifth tube is substantially perpendicular to the retainer, the first tube assembly, and the second tube assembly.

20. The apparatus of claim 1, wherein the second tube further comprises a global positioning system (GPS) indicator.

21. An apparatus, comprising:
a retainer to couple to a proximal end of a cable, wherein a distal end of the cable is attached to a motor vehicle;
a first tube assembly to couple to a first surface of the retainer, the first tube assembly comprising:
a first tube, the first tube further comprising:
a first end and a second end;
a first length,
a first inner diameter; and
a first outer diameter;
a second tube configured to receive the first tube, the second tube further comprising:
a first end and a second end;
a second length;
a second inner diameter that is greater than the first outer diameter; and
a second outer diameter; and
a second tube assembly coupled to a second surface of the retainer, the second tube assembly comprising:
a third tube, wherein the third tube further comprises:
a first end and a second end;
a third length;
a third inner diameter; and
a third outer diameter; and
a fourth tube configured to receive the third tube, the fourth tube further comprising:
a first end and a second end;
a fourth length;
a fourth inner diameter that is greater than the third outer diameter; and
a fourth outer diameter; and
a fifth tube to slidably encase the cable, the fifth tube further comprising:
a first end and a second end; and
a fifth length; and
a mounting plate to couple to the motor vehicle.

22. The apparatus of claim 21, wherein:
the second tube further comprises an opening to receive the first tube;
the first tube is non-rotatable with respect to the second tube upon insertion into the second tube;
the fourth tube further comprises an opening to receive the third tube; and
the third tube is non-rotatable with respect to the fourth tube upon insertion into the fourth tube.

23. The apparatus of claim 21, wherein:
the mounting plate further comprises a plurality of apertures; and
the mounting plate is coupled to an external surface of the motor vehicle at the aperture such that the mounting plate is substantially perpendicular to the fifth tube.
